(19) United States
(12) Patent Application Publication
(10) Pub. No.: US 2018/0254999 A1
(43) Pub. Date: Sep. 6, 2018

(54) MULTIDIMENSIONAL RESOURCE ALLOCATION IN DATA CENTERS

(71) Applicant: LinkedIn Corporation, Sunnyvale, CA (US)

(72) Inventors: Allan M. Caffee, Sunnyvale, CA (US); Pankit Thapar, Santa Clara, CA (US)

(73) Assignee: LinkedIn Corporation, Sunnyvale, CA (US)

(21) Appl. No.: 15/451,118

(22) Filed: Mar. 6, 2017

(51) Int. Cl. H04L 12/911

(52) U.S. Cl. CPC H04L 47/821; H04L 67/1097

(57) ABSTRACT

The disclosed embodiments provide a system for allocating resources to an application. During operation, the system obtains a set of resource requirements for the application, wherein the resource requirements include a processor allocation and a memory allocation. Next, the system identifies a set of hosts in a set of racks with available resources that meet the resource requirements. The system then selects, for the application, a rack in the set of racks based on a priority associated with resource allocation for the application and a host in the rack based on one or more additional priorities associated with resource allocation for the application. Finally, the system allocates the resources on the host to the application.

### BACKGROUND

### Field

The disclosed embodiments relate to techniques for scheduling resources in data centers. More specifically, the disclosed embodiments relate to techniques for performing multidimensional resource allocation in data centers.

### Related Art

Data centers and cloud computing systems are commonly used to run applications, provide services, and/or store data for organizations or users. Within the cloud computing systems, software providers may deploy, execute, and manage applications and services using shared infrastructure resources such as servers, networking equipment, virtualization software, environmental controls, power, and/or data center space. Some or all resources may also be dynamically allocated and/or scaled to enable consumption of the resources as services. Consequently, management and use of data centers may be facilitated by mechanisms for efficiently allocating and configuring infrastructure resources for use by applications.

### BRIEF DESCRIPTION OF THE FIGURES

FIG. 1 shows a schematic of a system in accordance with the disclosed embodiments.

FIG. 2 shows a system for allocating resources to applications in accordance with the disclosed embodiments.

FIG. 3 shows the allocation of resources to an application in accordance with the disclosed embodiments.

FIG. 4 shows a flowchart illustrating a process of allocating resources to an application in accordance with the disclosed embodiments.

FIG. 5 shows a flowchart illustrating a process of selecting a host for use in allocating resources to an application in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

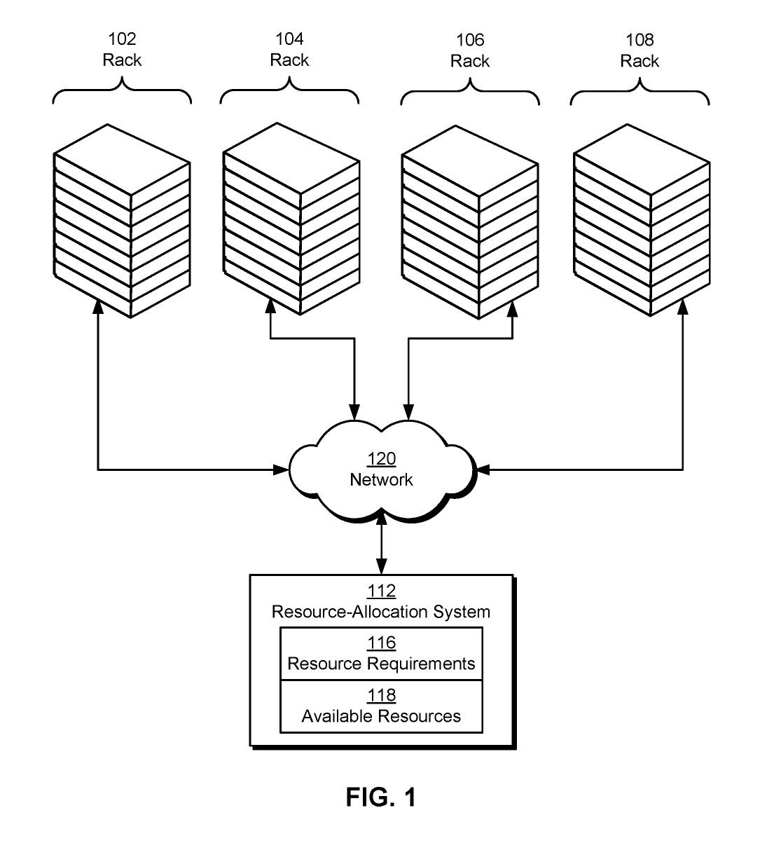

The disclosed embodiments provide a method, apparatus, and system for allocating resources to applications. As shown in FIG. 1, the applications may be deployed across a set of racks 102-108 in one or more data centers, collocation centers, cloud computing systems, clusters, and/or other collections of processing, storage, network, and/or other resources. Each rack may include a set of hosts (e.g., servers) on which the applications execute and/or one or more switches that connect the hosts to a network 120.

A resource-allocation system 112 may manage allocation of resources in racks 102-108 to the applications. In particular, resource-allocation system 112 may track available resources 118 as units of processing, storage, network, and/or other resources that are currently unallocated or unused on individual hosts in racks 102-108. When resources are to be allocated to an application, resource-allocation system 112 may obtain a processor allocation, memory allocation, and/or other resource requirements 116 for the application and identify a subset of hosts in racks 102-108 with available resources 118 that can accommodate resource requirements 116. Resource-allocation system 112 may then allocate resources that meet resource requirements 116 on one or more of the hosts.

In one or more embodiments, resource-allocation system 112 includes functionality to perform multidimensional allocation of resources in racks 102-108 to applications. As described in further detail below, such multidimensional resource allocation may balance multiple priorities associated with diversifying instances of individual applications across multiple racks and efficiently “packing” applications with different resource requirements 116 into available resources 118 on each host. As a result, resource-allocation system 112 may improve fault tolerance in the applications and utilization of resources in racks 102-108 over conventional resource-allocation techniques that assign resources to applications in a random and/or one-dimensional manner.

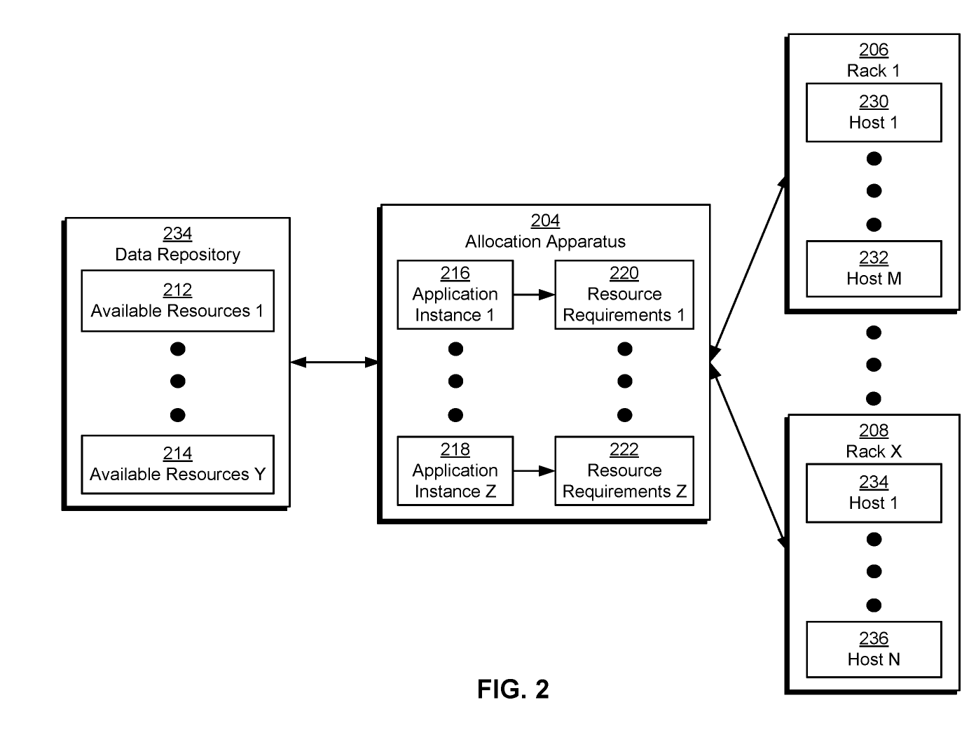

FIG. 2 shows a system for allocating resources to applications, such as resource-allocation system 112 of FIG. 1, in accordance with the disclosed embodiments. As shown in FIG. 2, the system includes an allocation apparatus 204 and a data repository 234. Each of these components is described in further detail below.

As mentioned above, the resources may be allocated to the applications from a number of hosts (e.g., host 1 230, host m 232, host 1 234, host n 236) that are arranged within a number of racks (e.g., rack 1 206, rack x 208). For example, the hosts and racks may be included in a data center, cluster, cloud computing system, collocation center, and/or other physical or virtual collection of resources. Each host may include a set of hardware (e.g., processor, memory, network, storage, etc.) and/or software (e.g., operating system, processes, file descriptors, services, etc.) resources, as well as a number of application instances (e.g., individual deployments or installations of applications) deployed on the host. Within a host, different application instances may execute using disparate, non-overlapping subsets of resources allocated to the application instances by the resource-allocation system.

Data repository 234 may maintain records of available resources (e.g., available resources 1 212, available resources y 214) in the hosts. For example, data repository 234 may store, for each host, a record of total and unused processor, memory, network, storage, software, and/or other resources on the host. The record may also identify application instances on the host, the resources allocated to each application instance on the host, and/or a rack in which the host resides.

Allocation apparatus 204 may use data in data repository 234 to allocate resources on the hosts to application instances. First, allocation apparatus 204 may obtain a set of resource requirements (e.g., resource requirements 1 220, resource requirements z 222) for each application instance (e.g., application instance 1 216, application instance z 218). For example, allocation apparatus 204 may obtain the resource requirements through an application-programming interface (API) for the resource-allocation system, a configuration file for each application, and/or another mechanism. The resource requirements may be specified to allocation apparatus 204 prior to application deployment and/or when the workload, demands, operation, and/or needs of an executing application have changed.

Each set of resource requirements may specify numbers and/or types of resources required by the corresponding application instance to execute. For example, the resource requirements may include a processor allocation (e.g., number of processor cores), memory allocation (e.g., units of memory and/or units of a specific type of memory), storage requirement (e.g., solid-state drives (SSDs), disk capacity, etc.), and/or network requirement (e.g., network distance from other applications or application instances, bandwidth, network access criteria, etc.). The resource requirements may also include a software requirement (e.g., operating system, kernel profile, number of file descriptors, number of processes, software profile, etc.), containerization requirement (e.g., containerization capabilities, level of isolation, enforcement of resource allocations, etc.), external device requirement (e.g., use of a physical mobile device for testing instead of a virtualized environment), and/or a graphics-processing unit (GPU) allocation (e.g., number of GPU cores).

Next, allocation apparatus 204 may retrieve, from data repository 234, one or more sets of available resources that meet the resource requirements of each application instance. For example, allocation apparatus 204 may provide the resource requirements as parameters of a query to data repository 234, and data repository 234 may respond to the query with a set of hosts containing available resources that meet the resource requirements.

Allocation apparatus 204 may then select, from the set of hosts retrieved from data repository 234, a host for the application instance and allocate a set of resources on the host that meet the resource requirements to the application. For example, allocation apparatus 204 may select a random host from the set of hosts and/or a host based on a suggestion (e.g., host ID, host location, rack, etc.) from a client requesting the allocation. After the host is selected for the application, allocation apparatus 204 may allocate resources on the host to the application by decrementing, in a centralized record for the host in data repository 234, the available resources on the host by the resource requirements of the application instance.

After the allocation is complete, allocation apparatus 204 may optionally deploy the application instance on the allocated resources. For example, allocation apparatus 204 may record, in data repository 234 and/or another repository of deployment data for application instances, an intended deployment of the application instance on the allocated resources. Allocation apparatus 204 and/or another component may then deploy the application instance within a container on the host and update the repository with an applied deployment of the application instance on the allocated resources. The component may also configure the container according to one or more containerization requirements (e.g., isolation boundaries, namespaces, etc.) from the resource requirements of the application instance.

Multiple instances of allocation apparatus 204 may also execute to process requests for resource allocations and/or data from data repository 234 in parallel. When an instance of allocation apparatus 204 receives a request to allocate resources to an application instance, the instance may retrieve a set of hosts with available resources that meet the resource requirements of the application instance from data repository 234. The instance may then select a host from the retrieved set of hosts and attempt to allocate resources on the host to the application instance by updating the record for the host in data repository 234 with the allocation. If another instance of allocation apparatus 204 has already allocated some or all of the available resources on the host to another application instance (e.g., during the period between retrieving the set of hosts and transmitting a write request for the record from the instance to data repository 234), the attempted allocation may fail. In response, the instance may retry the allocation with the same host (e.g., if remaining available resources on the host can still accommodate the resource requirements of the application instance) or with a different host that has available resources that meet the application instance's resource requirements. In other words, allocation apparatus 204 and/or data repository 234 may implement optimistic concurrency control during allocation of resources to application instances.

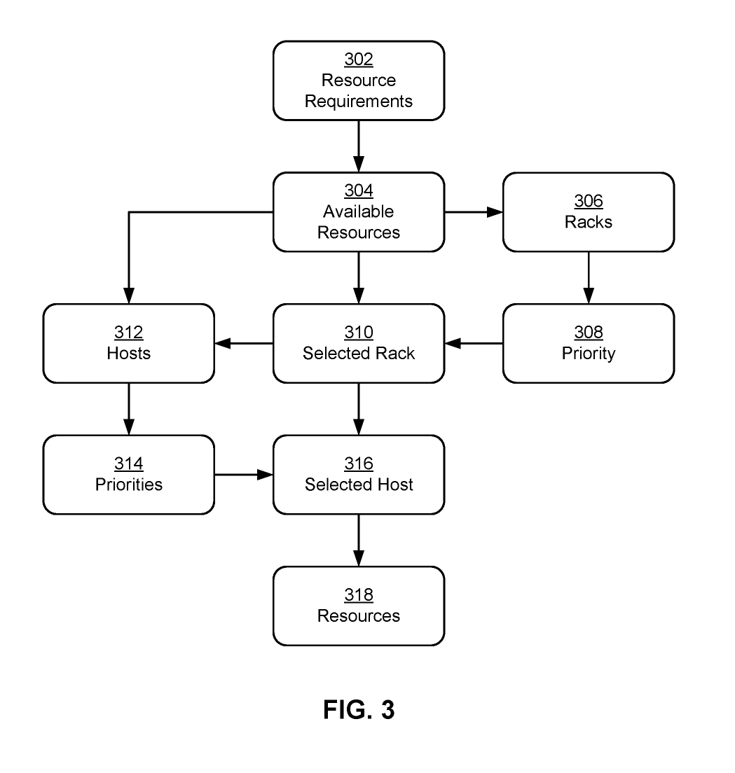

In one or more embodiments, the system of FIG. 2 includes functionality to allocate resources on the hosts to the application instances based on a number of priorities associated with resource allocation for the application instances. As discussed in further below with respect to FIG. 3, allocation apparatus 204 may initially prioritize diversifying instances of each application across multiple racks. For example, allocation apparatus 204 may select, from a number of racks containing hosts with available resources that can meet the resource requirements of an application instance, a rack containing the fewest deployed instances of the same application.

Next, allocation apparatus 204 may prioritize efficient use of resources in the rack by the application instance. Continuing with the previous example, allocation apparatus 204 may select, from the hosts in the rack, a host with the smallest set of available resources that can accommodate the resource requirements of the application instance. Consequently, the system of FIG. 2 may improve the fault tolerance of applications executing on the hosts (e.g., by decreasing the likelihood that a failure in a server, rack, or other subset of resources will bring down all instances of an application) and increase utilization of resources on the hosts by the applications (e.g., by “packing” the applications onto available resources of the hosts).

Those skilled in the art will appreciate that the system of FIG. 2 may be implemented in a variety of ways. More specifically, allocation apparatus 204 and data repository 234 may be provided by a single physical machine, multiple computer systems, one or more virtual machines, a grid, one or more databases, one or more filesystems, and/or a cloud computing system. Allocation apparatus 204 and data repository 234 may additionally be implemented together and/or separately by one or more hardware and/or software components and/or layers. For example, allocation apparatus 204 may serve as a frontend component that provides an API for allocating resources in the hosts to application instances and/or retrieving data related to the resource allocations, available resources, hosts, and/or application instances from data repository 234. In turn, allocation apparatus 204 may execute queries with data repository 234 to allocate the resources and/or retrieve the requested information.

FIG. 3 shows the allocation of a set of resources 318 to an application in accordance with the disclosed embodiments. As mentioned above, resources 318 may be allocated according to a set of resource requirements 302 for an instance of the application. For example, the application instance may be defined with a required number of processor cores, number of GPU cores, gigabytes of memory or storage, number of processes, number of file descriptors, and/or amount of other hardware or software resources. The application instance may also include requirements associated with types or configurations of resources, such as kernel profiles, software profiles, types of storage devices, types of memory, types of containerization, and/or network access criteria.

Resource requirements 302 may be matched to sets of available resources 304 that meet or exceed resource requirements 302. For example, resource requirements 302 may be provided in a query to a data repository (e.g., data repository 234 of FIG. 2) that tracks resource allocations in one or more data centers, cloud computing systems, collocation centers, clusters, and/or other collections of infrastructure resources. In response to the query, the data repository may return a set of hosts, virtual machines, and/or other nodes with available resources 304 that can accommodate the required types or amounts of processor, GPU, memory, storage, network, software, containerization, external device, and/or other resources.

Next, a set of racks 306 containing available resources 304 is identified. Continuing with the previous example, data returned by the data repository may identify hosts with available resources 304 that meet resource requirements 302, along with racks 306 containing the hosts.

A priority 308 associated with resource allocation for the application is then used to produce a selected rack 310 for the application from the set of racks 306. For example, priority 308 may include diversifying instances of the application across multiple racks to improve the fault tolerance of the application. As a result, selected rack 310 may be obtained as the first rack in a priority queue that sorts racks 306 by increasing number of instances of the application on each rack. Alternatively, selected rack 310 may be produced based on other criteria, such as a “diversity factor” that specifies an ideal or minimum number of racks across which instances of the same application are deployed. Thus, selected rack 310 may be chosen as a rack containing zero instances of the application when the minimum proportion is not met and a rack containing zero or more instances of the application when the minimum proportion is met. The diversity factor may also, or instead, indicate a maximum number of instances of the same application that should be deployed on a given rack. In turn, selected rack 310 may be chosen as a rack that contains fewer than the maximum number of instances of the application.

Within selected rack 310, a set of hosts 312 with available resources 304 that meet resource requirements 302 may be assessed according to one or more additional priorities 314 and used to produce a selected host 316 for the application. For example, priorities 314 may include matching a number of resource requirements 302 to the host in selected rack 310 with the smallest corresponding set of available resources. To obtain selected host 316, a first ordering of hosts 312 may be generated according to a first priority (e.g., processor allocation) in priorities 314, and a group of hosts with equal rank in the first ordering (e.g., hosts with the same smallest number of available processors that meets the processor allocation) may be identified. A second ordering of the group of hosts may then be generated according to a second priority (e.g., memory allocation) in priorities 314, and host 316 may be obtained from the second ordering as the host with the smallest set of available resources (e.g., the smallest amount of available memory) that meets the resource requirement associated with the second priority. In other words, priorities 314 may be used to “pack” the application instance into the smallest set of available resources in selected host 316, allowing hosts with larger amounts of available resources 304 to accommodate application instances with larger resource requirements.

In another example, priorities 308 and/or 314 may be included in an optimization problem that seeks to minimize the number of hosts required to execute the application instances while maximizing the number of racks across which the application instances are deployed. In turn, an optimization technique such as a branch and bound method may be applied to priorities 308 and 314, resource requirements 302, and available resources 304 specified in an objective function and/or constraints in the optimization problem to obtain an optimal set of resource allocations on the hosts to the application instances.

After selected host 316 is identified, resources 318 that meet resource requirements 302 on selected host 316 may be allocated to the application instance. For example, the allocation may be performed by updating, in the data repository, a centralized record of available resources 304 on selected host 316 with the allocated resources 318. Conversely, the allocation may fail if some or all resources 318 have already been allocated to another application instance during the period between the retrieval of available resources 304 from the centralized record and an attempt to decrement allocated resources 318 from available resources 304 in the centralized record. If the allocation fails, a new selected rack 310 and/or selected host 316 for the application instance may be produced from the previously retrieved available resources 304 and/or an updated set of available resources 304 from the data repository. Resources 318 may then be allocated from the newly selected host 316 as long as some or all resources 318 have not already been allocated to another application instance.

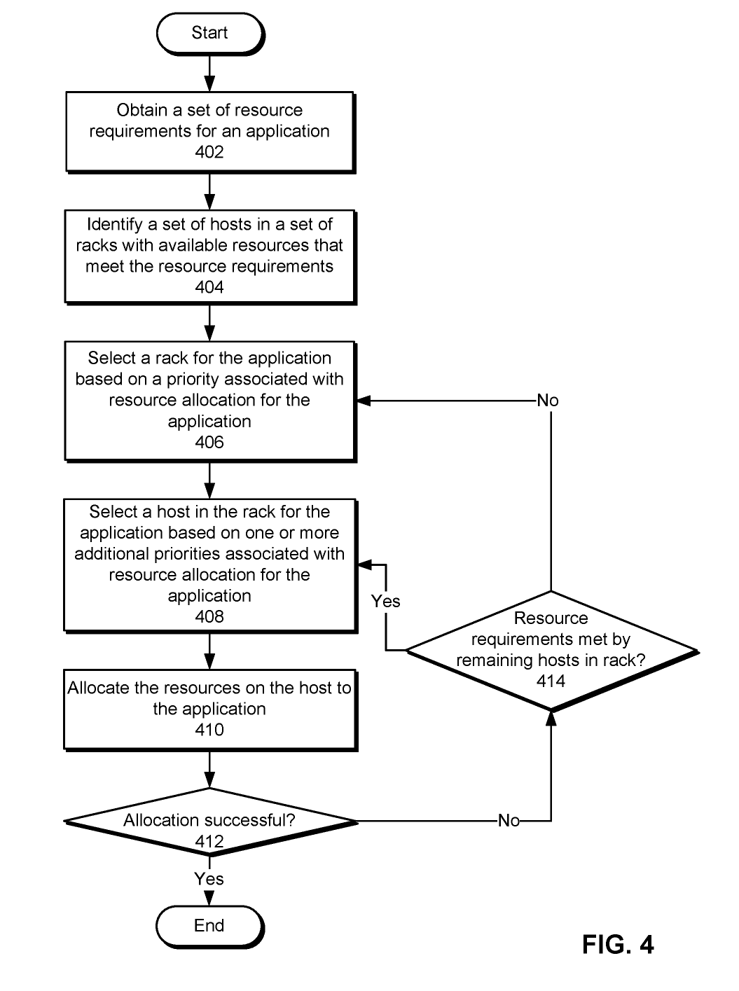

FIG. 4 shows a flowchart illustrating a process of allocating resources to an application in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a set of resource requirements for an application is obtained (operation 402). For example, the resource requirements may include a processor allocation, memory allocation, storage requirement, network requirement, software requirement, containerization requirement, external device requirement, and/or GPU allocation. The resource requirements may be obtained prior to deploying the application and/or when the resource requirements of the application have changed.

Next, a set of hosts in a set of racks with available resources that meet the resource requirements is identified (operation 404). For example, the resource requirements may be matched to centralized records of available resources in a data repository (e.g., data repository 234 of FIG. 2) and used to obtain a subset of hosts in a data center, cluster, collocation center, cloud computing system, and/or other pool of resources with unused resources that can accommodate the resource requirements.

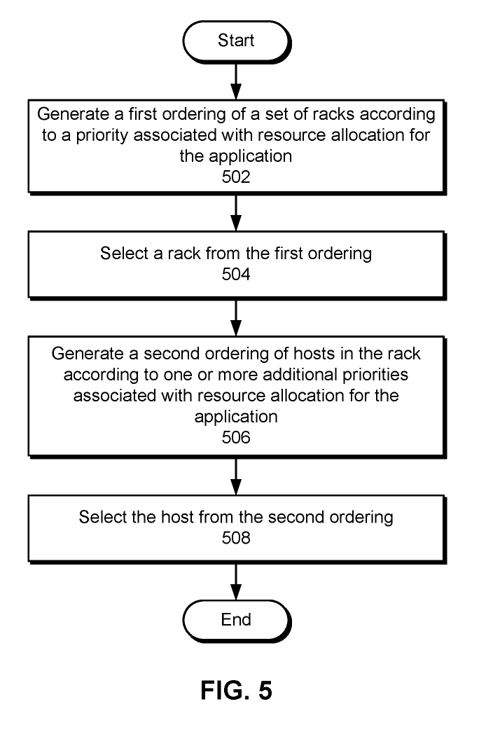

A rack for the application is then selected based on a priority associated with resource allocation for the application (operation 406), and a host in the rack is selected for the application based on one or more additional priorities associated with resource allocation for the application (operation 408), as described in further detail below with respect to FIG. 5. The resources on the host are then allocated to the application (operation 410). For example, the allocation may be performed by updating a centralized record of the available resources on the host with the allocated resources (e.g., by removing the allocated resources from the available resources and adding the allocated resources to a record for the application instance).

Subsequent resource allocation associated with the application may be conducted based on a success of the allocation (operation 412). Continuing with the previous example, the allocation may fail if the update is rejected because the centralized record was previously updated with an allocation of resources on the host to another application instance. If the allocation succeeds (e.g., if the update is not rejected), no additional resource allocation for the application is required.

If the allocation is not successful, remaining hosts in the rack may be searched for resources that meet the resource requirements (operation 414). If the resource requirements are met by one or more remaining hosts in the rack (e.g., based on available resources obtained in operation 404), another host containing resources that meet the resource requirements is selected (operation 408) from the remaining hosts, and resources on the newly selected host are allocated to the application (operation 410). Operations 408-410 may be repeated until resources from one of the remaining hosts are successfully allocated to the application, or until no remaining hosts in the rack can meet the resource requirements.

If none of the remaining hosts in the rack can meet the resource requirements, a new rack is selected (operation 406) according to the priority, and a new host with resources that meets the resource requirements in the new rack is selected (operation 408). The resources on the new host are then allocated to the application (operation 410), with the failure of the allocation (operation 412) leading to additional selection of racks and/or hosts until an allocation of resources that meets the resource requirements to the application finally succeeds. Alternatively, if resources cannot be allocated to the application from all hosts identified in operation 404, the pool of resources may currently be unable to accommodate the resource requirements of the application. Operations 402-412 may subsequently be repeated after additional hosts and/or racks are added to the pool of resources and/or after resources are de-allocated from one or more application instances executing in the pool of resources.

FIG. 5 shows a flowchart illustrating a process of selecting a host for use in allocating resources to an application in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

Initially, a first ordering of a set of racks is generated according to a priority associated with resource allocation for the application (operation 502), and a rack is selected from the first ordering (operation 504). The priority may include diversifying instances of the application across multiple racks. As a result, the racks may be ordered by increasing number of instances of the application, and a rack with the lowest number of instances of the application may be selected. The rack may also, or instead, be selected based on a “diversity factor” that aims to spread instances of the application across a minimum number of racks. For example, a diversity factor of 0.5 may indicate that the total number of instances of the application should be spread across at least half as many racks. In turn, 10 instances of the application may be spread across at least five racks to achieve the diversity factor. The diversity factor may additionally or alternatively aim to reduce the number of application instances on a single rack. For example, the diversity factor may be set to a whole number that represents the maximum number of instances of the same application that should be deployed on the same rack. Thus, racks with fewer than the maximum number of instances of the application may be prioritized over other racks.

Next, a second ordering of hosts in the rack is generated according to one or more additional priorities associated with resource allocation for the application (operation 506), and the host is selected from the second ordering (operation 508). The additional priorities may include matching one or more of the resource requirements of the application to the host with the smallest set of available resources. As a result, the hosts may be ordered according to a first priority in the additional priorities, such as availability of a first resource (e.g., number of unused processor cores, amount of unused memory, etc.). Next, a group of hosts with equal rank in the ordered hosts may be obtained and ordered according to a second priority in the additional priorities, such as availability of a second resource, and the host may be selected from the ordered group of hosts. For example, hosts in the rack may first be ordered by the number of unused processor cores, and the ordering may be used to identify a group of hosts with an identical lowest number of unused processor cores that meets the required processor allocation for the application. The group of hosts may then be ordered by unused memory, and a host with the smallest amount of unused memory that meets the required memory allocation for the application may be selected.

Alternatively, an optimization technique may be used to select the rack and/or host for the application. For example, priorities associated with selecting the rack and/or host may be specified in an optimization problem that seeks to maximize diversification of application instances on multiple racks and utilization of available resources in hosts on the racks by reducing the number of hosts required to execute application instances while increasing the number of racks across which the application instances are deployed. In turn, a branch and bound method may be applied to the resource requirements of the application, the priorities, and the available resources on the hosts to obtain an optimal set of assignments of application instances to hosts and/or racks based on an objective function and/or constraints in the optimization problem.

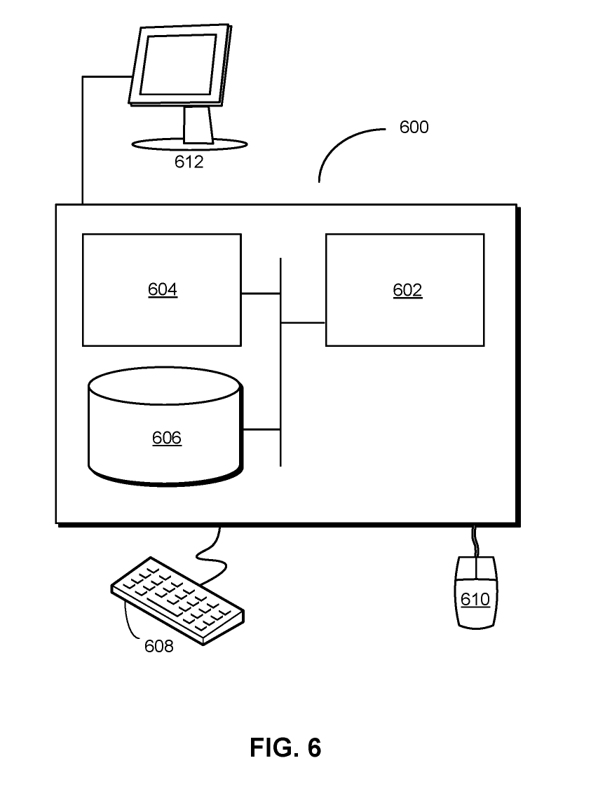

FIG. 6 shows a computer system 600 in accordance with the disclosed embodiments. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for allocating resources to an application. The system may include a data repository and an allocation apparatus. The data repository may track available resources in a data center. In turn, the allocation apparatus may obtain a set of resource requirements for the application and query the data repository to identify, in the data center, a set of hosts in a set of racks with available resources that meet the resource requirements. Next, the allocation apparatus may select, for the application, a rack in the set of racks based on a priority associated with resource allocation for the application. The allocation apparatus may then select, for the application, a host in the rack based on one or more additional priorities associated with resource allocation for the application. Finally, the allocation apparatus may allocate the resources on the host to the application.

In addition, one or more components of computer system 600 may be remotely located and connected to the other components over a network. Portions of the present embodiments (e.g., allocation apparatus, data repository, application instances, hosts, racks, etc.) may also be located on different nodes of a distributed system that implements the embodiments. For example, the present embodiments may be implemented using a cloud computing system that allocates resources on a pool of remote resources to application instances.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of resource requirements for an application, wherein the resource requirements comprise a processor allocation and a memory allocation;
allocating a set of resources that meets the resource requirements to the application by performing the following operations on a computer system:
identifying a set of hosts in a set of racks with available resources that meet the resource requirements;
selecting, for the application, a rack in the set of racks based on a priority associated with resource allocation for the application;
selecting, for the application, a host from a subset of the hosts in the rack based on one or more additional priorities associated with resource allocation for the application; and
allocating the resources on the host to the application.

2. The method of claim 1, further comprising:
selecting the host for use in allocating additional resources to an additional application; and
when the host lacks the additional resources to meet additional resource requirements of the additional application after the resources are allocated to the application, searching remaining hosts in the rack for the additional resources.

3. The method of claim 2, further comprising:
when the remaining hosts in the rack lack the additional resources to meet the additional resource requirements:
selecting another rack for the additional application;
selecting another host in the other rack with the additional resources; and
allocating the additional resources on the other host to the additional application.

4. The method of claim 1, wherein selecting the rack in the set of racks based on the priority comprises:
generating an ordering of the racks according to the priority; and
selecting the rack from the ordering.

5. The method of claim 1, wherein selecting the host based on the one or more additional priorities comprises:
generating an ordering of the subset of the hosts in the rack according to the one or more additional priorities; and
selecting the host from the ordering.

6. The method of claim 5, wherein generating the ordering of the subset of the hosts according to the one or more additional priorities comprises:
ordering the subset of the hosts according to a first priority in the one or more additional priorities;
obtaining a group of hosts with equal rank in the ordered subset of hosts; and
ordering the group of hosts according to a second priority in the one or more additional priorities.

7. The method of claim 5, wherein the one or more additional priorities comprise matching one or more of the resource requirements to the host with a smallest set of available resources.

8. The method of claim 1, wherein selecting the host based on the one or more additional priorities comprises:
applying an optimization technique to the resource requirements, the priority, and the available resources to select the host with the set of resources that meets the resource requirements.

9. The method of claim 1, wherein the priority comprises diversifying instances of the application across multiple racks.

10. The method of claim 1, wherein the set of resource requirements further comprises at least one of:
a storage requirement;
a network requirement;
a software requirement;
a containerization requirement;
an external device requirement; and
a graphics-processing unit (GPU) allocation.

11. The method of claim 1, wherein allocating the resources on the host to the application comprises:
updating a centralized record of the available resources on the host with the allocated resources.

12. An apparatus, comprising:
one or more processors; and
memory storing instructions that, when executed by the one or more processors, cause the apparatus to:
obtain a set of resource requirements for an application, wherein the resource requirements comprise a processor allocation and a memory allocation;
identify a set of hosts in a set of racks with available resources that meet the resource requirements;
select, for the application, a rack in the set of racks based on a priority associated with resource allocation for the application;
select, for the application, a host in the rack based on one or more additional priorities associated with resource allocation for the application; and
allocate the resources on the host to the application.

13. The apparatus of claim 12, wherein the memory further stores instructions that, when executed by the one or more processors, cause the apparatus to:
select the host for use in allocating additional resources to an additional application; and
when the host lacks the additional resources to meet additional resource requirements of the additional application after the resources are allocated to the application, search remaining hosts in the rack for the additional resources.

14. The apparatus of claim 13, wherein the memory further stores instructions that, when executed by the one or more processors, cause the apparatus to:
when the remaining hosts in the rack lack the additional resources to meet the additional resource requirements:
select another rack for the additional application;
select another host in the other rack with the additional resources; and
allocate the additional resources on the other host to the additional application.

15. The apparatus of claim 12, wherein selecting the host based on the one or more additional priorities comprises:
ordering the subset of the hosts according to a first priority in the one or more additional priorities;
obtaining a group of hosts with equal rank in the ordered subset of hosts;
ordering the group of hosts according to a second priority in the one or more additional priorities; and
selecting the host from the ordered group of hosts.

16. The apparatus of claim 12, wherein selecting the host based on the one or more additional priorities comprises:
applying an optimization technique to the resource requirements, the priority, and the available resources to select the host with the set of resources that meets the resource requirements.

17. The apparatus of claim 12, wherein the priority comprises diversifying instances of the application across multiple racks.

18. The apparatus of claim 12, wherein the set of resource requirements further comprises at least one of:
a storage requirement;
a network requirement;
a software requirement;
a containerization requirement;
an external device requirement; and
a graphics-processing unit (GPU) allocation.

19. A system, comprising:
a data repository comprising a non-transitory computer-readable medium comprising instructions that, when executed, cause the system to track available resources in a data center; and
an allocation module comprising a non-transitory computer-readable medium comprising instructions that, when executed, cause the system to:
obtain a set of resource requirements for an application, wherein the resource requirements comprise a processor allocation and a memory allocation;
query the data repository to identify, in the data center, a set of hosts in a set of racks with available resources that meet the resource requirements;
select, for the application, a rack in the set of racks based on a priority associated with resource allocation for the application;
select, for the application, a host in the rack based on one or more additional priorities associated with resource allocation for the application; and
allocate the resources on the host to the application.

20. The system of claim 19, wherein the set of resource requirements further comprises at least one of:
a storage requirement;
a network requirement;
a software requirement;
a containerization requirement;
an external device requirement; and
a graphics-processing unit (GPU) allocation.
